(19) United States
(12) Patent Application Publication
(10) Pub. No.: US 2024/0114017 A1
(43) Pub. Date: Apr. 4, 2024

(54) Remote Function Unlock for Scan Tool

(71) Applicant: Robert Bosch GmbH, Stuttgart (DE)

(72) Inventors: Jayadevan Maniyullavaluppil, Owatonna, MN (US); Abhishek Pradhan, Lakeville, MN (US)

(21) Appl. No.: 17/955,845

(22) Filed: Sep. 29, 2022

(51) Int. Cl. H04L 9/40; G06Q 30/04; G07C 5/00; G07C 5/08

(52) U.S. Cl. CPC H04L 63/08; G06Q 30/04; G07C 5/008; G07C 5/0808; G07C 2205/02

(57) ABSTRACT

A diagnostic system and method for providing service functions to a vehicle under service. The system and method utilize a scan tool in data communication with an authorization gateway. The gateway is suitable to provide authorization for some service functions of the scan tool. The gateway is in communication with external devices, such as specialized machines or remote scan tools, that may be utilized to provide authorization for additional service functions of the scan tool. The gateway may be in data communication with a billing server to generate billing data for the user of the scan tool.

### TECHNICAL FIELD

This disclosure relates to the servicing of a vehicle including diagnostic procedures.

### BACKGROUND

Vehicle diagnostic services are an important aspect of modern vehicle servicing. It is critical to accurately assess the operational condition of a vehicle prior to performing any service such as maintenance, calibration, or repair. An accurate assessment of the vehicle's condition can guide service personnel to an expedient and proficient performance of the necessary service tasks.

Accurate assessments of the vehicle's condition may require extensive and specialized technical knowledge. Modern vehicles may provide insights to their operational condition utilizing electronic data communication. Electronic data indicating the operational condition of the vehicle may be generated, such as diagnostic codes associated with the vehicle, a component of the vehicle, or one of the vehicle's systems. Additionally, several factors may complicate the diagnostic process and subsequent repairs. Technicians must be able to acquire vehicle operational data from the vehicle as well as vehicle ID data, as different manufacturers may utilize similar or identical operational data or diagnostic codes that have completely distinct meanings in the context of their respective vehicles. Vehicle operational data may differ from vehicle to vehicle, from component to component, and even from year to year of the same vehicle or component thereof. Additionally, the manufacturers may choose to restrict access to some data useful in completing a diagnostic service for reasons of safety, security, or intellectual property. This limited-access data may be desirable because it is for emerging technologies or for a newly released vehicle, component, or system. This diagnostic service is additionally complicated when accounting for aftermarket components and systems that may behave differently from their respective stock models. Thus, a comprehensive diagnostic service may require a level of technical know-how that is both broad and deep, which may be expensive to acquire or maintain.

It would therefore be desirable to have a system that provides technicians or other service personnel with guidance and access to a wide range of diagnostic data corresponding to a wide range of vehicle types, vehicle components, and vehicle systems that may be encountered. It may further be advantageous to provide the system in such a way that access to the desired diagnostic data may be accomplished at a reduced cost.

### SUMMARY

One aspect of this disclosure is directed to a method of operating a scan tool for a vehicle. The method may comprise obtaining identification data from the vehicle. The identification data may identify the make and model of the vehicle, as well as a user of a scan tool. The method may further comprise obtaining a code from the vehicle indicating diagnostic service needs of the vehicle and identifying a service operation suitable for the vehicle based on the identification data and the code. The service operation may have a classification type, and the method may further comprise determining if an authorization is necessary for completion of the service operation based on the classification type. If authorization is required, the method may comprise requesting an authorization from an authorization gateway in response to the classification type and receiving the authorization from the authorization gateway in response to the request. After needed authorization is obtained, the method may proceed with executing the service operation.

Another aspect of this disclosure is directed to a diagnostics system for performing service functions on a vehicle under service. The system comprises a scan tool having a tool processor and a tool memory. The scan tool is configured to establish a diagnostics communication with the vehicle under service. The system further comprises an authorization gateway in data communication with the scan tool, the authorization gateway having a gateway processor and a gateway memory. The diagnostics system further comprises a specialized machine in data communication with the authorization gateway, the specialized machine comprising a specialized processor and a specialized memory. The tool memory comprises executable instructions for a number of service functions, some of the service functions having a classified type requiring an authorization to be operable by the scan tool. The gateway memory comprises a number of first authorization assets to enable the scan tool to perform a service function having a first classified type. The specialized memory comprises a number of second authorization assets to enable the scan tool to perform a service function having a second classified type, wherein the scan tool is configured to request a first authorization asset prior to performing a service function of the first classified type. The scan tool is configured to request a second authorization asset prior to performing a service function of the second classified type.

A further aspect of this disclosure is directed to a scan tool for servicing a vehicle, the scan tool comprising a tool processor and a tool memory. The tool memory comprises instructions stored thereon that, when executed by the tool processor, cause the tool processor to perform the steps of a method of operation. The scan tool first obtains identification data from the vehicle, the identification data identifying the make and model of the vehicle. The scan tool then obtains a code from the vehicle indicating diagnostic service needs of the vehicle. The scan tool then identifies a service operation suitable for the vehicle in response to the identification data and the code. The service operation has a classification type, and the scan tool then determines if an authorization is necessary for completion of the service operation based on the classification type. The scan tool then requests an authorization from an authorization gateway in response to the classification type necessitating an authorization before executing the service operation. After receiving the authorization from the authorization gateway in response to the request, the scan tool executes the service operation.

The above aspects of this disclosure and other aspects will be explained in greater detail below with reference to the attached drawings.

### BRIEF DESCRIPTION OF THE DRAWINGS

FIG. 1 is a diagrammatic view of a diagnostics system according to one embodiment of the teachings herein.

FIG. 2 is a diagrammatic view of a diagnostics system according to another embodiment of the teachings herein.

FIG. 3 is a flowchart illustrating a diagnostic method for use during service of a vehicle.

FIG. 4 is a flowchart illustrating sub-steps of one of the steps of FIG. 3 according to one embodiment of the teachings disclosed herein.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

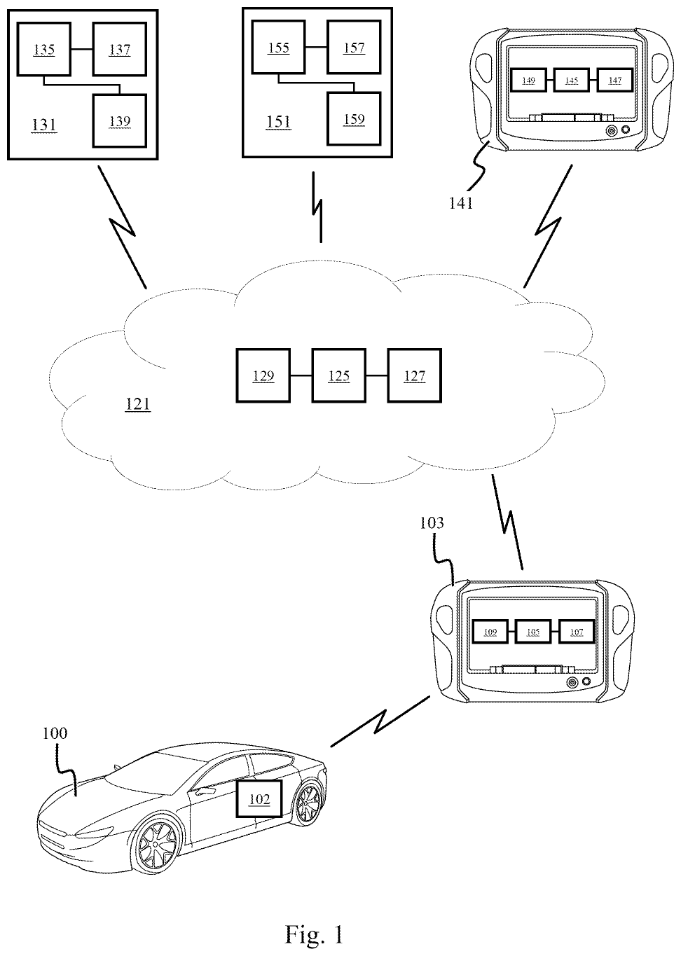

FIG. 1 shows a diagrammatic illustration of a diagnostic system for providing diagnostics and service of a vehicle 100 having a vehicle communication interface (VCI) 102. A user interacts with VCI 102 using a scan tool 103 having a tool processor 105, and a tool memory 107 and tool transceiver 109, each in data communication with tool processor 105. Tool transceiver 109 is configured to exchange data, commands, and communications with devices external to scan tool 103. In the depicted embodiment, tool transceiver 109 provides bi-directional communication, command, and data exchange, but other embodiments may comprise a separate receiver and transmitter without deviating from the teachings disclosed herein.

In the depicted embodiment, the data communication between scan tool 103 and VCI 102 is accomplished wirelessly, but other embodiments may comprise additional or other configurations without deviating from the teachings disclosed herein. In some embodiments, scan tool 103 may comprise one or more wired communication ports to provide data communication with external devices. By way of example, and not limitation, scan tool 103 may comprise a connector port that supports a hardwire communication with a vehicle such as vehicle 100 via an onboard diagnostic (OBD) protocol. Some embodiments of scan tool 103 may comprise both wired and wireless connectivity without deviating from the teachings disclosed herein.

Tool memory 107 stores thereon a number of diagnostic functions and service functions that may be executed by tool processor 105. Tool memory 107 may store these functions in a read-only memory (ROM), a firmware memory, or a writable memory. Utilization of a writable memory is advantageous because it permits the library of functions available to scan tool 103 to be updated and expanded over time, such as by receiving additional functions via tool transceiver 109. Other embodiments may utilize other forms of memory without deviating from the teachings disclosed herein.

Tool memory 107 additionally stores thereon a set of diagnostic information suitable to determine necessary service or additional diagnostic functions after scan tool 103 receives diagnostic data from the VCI 102 indicating the operating condition of vehicle 100. By way of example, and not limitation, the diagnostic data generated by VCI 102 may comprise codes, such as a diagnostic trouble code (DTC), indicating a particular condition. The codes generated by VCI 102 may have meanings distinct to a particular make or model of vehicle 100. Tool memory 107 additionally may advantageously comprise sufficient information to distinguish the meanings for these codes for a variety of makes or models of vehicles under service.

Some of the diagnostic and service functions that may be performed by scan tool 103 may be restricted and require authorization. For example, an original equipment manufacturer (OEM) may require that some functions only be performed by an authorized tool in order to preserve the warranty of one or more parts of vehicle 100. In another example, the OEM may have contractual requirements established with a technician or manufacturer or other components of the vehicle 100 (such as an after-market component) that requires a technician to complete a service or diagnostic with an authorized tool. In another example, an insurance company may only provide payment for a service or diagnostic if an authorized tool is used to perform one or more of the functions of that service or diagnostic. In another example, an OEM may require a licensed authorization of a tool to perform a service or diagnostic in order to maintain the security of programming code associated with that service or diagnostic. Other reasons for authorization may be understood to one of ordinary skill, and other reasons may be utilized without deviating from the teachings disclosed herein.

Functions listed in tool memory 107 may be associated with a classification type that indicates a level of authorization necessary for scan tool 103 to utilize each particular service function or diagnostic function. A first classification type is a “native-controlled type.” Native-controlled type functions are those functions which do not require any authorization that cannot be accessed without communication with an external device. Native-controlled type functions may be performed by the scan tool 103 in an unrestricted fashion. Some native-controlled type functions may be restricted but authorized via functions native to the scan tool, such as a password, biometric identification, user login, or identification card reader. Other embodiments may comprise other native-controlled type authorization schema without deviating from the teachings disclosed herein.

Additional functions having other classification types will result in scan tool 103 exchanging information with an authorization gateway 121, comprising a gateway processor 125, gateway memory 127, and gateway transceiver 129, though other embodiments may comprise a distinct transmitter and receiver without deviating from the teachings disclosed herein. Gateway 121 provides authorization for functions in response to requests from scan tool 103. Gateway 121 may provide the authorizations directly to scan tool 103, or it may act as a conduit for an authorization acquired from an external device in data communication with gateway 121. By way of example, and not limitation, gateway memory 127 may store thereon digital information comprising an authorization code or token to be passed to scan tool 103. When the classification type of a function of scan tool 103 comprises a “gateway-controlled” type, then gateway 121 is sufficient to provide the authorization for the function without relying upon any additional external device. Some gateway-controlled type functions may be restricted via additional identifying information of the scan tool 103 or a user thereof. By way of example, and not limitation, additional identifying information may comprise a password, biometric identification, user login, or identification card reader. Other embodiments may comprise other gateway-controlled type authorization schema without deviating from the teachings disclosed herein. Gateway-controlled type functions are accessible using only resources available to gateway 121 and scan tool 103.

Other functions may have other classification types that cannot be resolved by gateway 121 alone. Some functions may be classified as a “machine-controlled” type, which requires a specialized machine external to both scan tool 103 and gateway 121 to provide authorization for operation of the associated function. In the depicted embodiment, a specialized machine 131 is in data communication with gateway 121, and is configured to provide authorizations for functions having a machine-controlled type. Specialized machine 131 comprises a specialized processor 135, a specialized memory 137, and a specialized transceiver 139, though other embodiments may comprise a distinct transmitter and receiver without deviating from the teachings disclosed herein. Specialized memory 137 may store thereon authorization codes, tokens, or other computing resources sufficient to authorize one or more machine-controlled functions of scan tool 103.

In the depicted embodiment, the authorization provided by specialized machine 131 may comprise establishing a data connection with scan tool 103 using gateway 121 as an intermediary connection. Once the connection is established, specialized machine 131 may provide code executable by tool processor 105 that instantiates an emulation mode for scan tool 103. In the emulation mode, scan tool 103 replicates perfectly a service function that is not normally available to scan tool 103, such as functions native to an OEM scan tool.

Some machine-controlled type functions may be restricted via additional identifying information of the scan tool 103 or a user thereof. By way of example, and not limitation, additional identifying information may comprise a password, biometric identification, user login, or identification card reader. Other embodiments may comprise other machine-controlled type authorization schema without deviating from the teachings disclosed herein. Machine-controlled type functions may be accessible using only resources available to specialized machine 131 and scan tool 103, or in some embodiments may rely upon resources available to gateway 121. In some embodiments, a plurality of specialized machines 131 may be utilized in coordination with gateway 121 and scan tool 103 to activate and operate machine-controlled type functions without deviating from the teachings disclosed herein.

In the depicted embodiment, some machine-controlled type functions may be authorized not by a specialized machine 131, but instead by a remote scan tool 141. Remote scan tool 141 comprises a remote processor 145, remote memory 147, and remote transceiver 149, though other embodiments may comprise a distinct transmitter and receiver without deviating from the teachings disclosed herein. Remote scan tool 141 may comprise a specialized scan tool having specialized data stored thereon suitable to perform specialized machine-controlled type functions. In the depicted embodiment, remote scant tool 141 may establish data communication with scan tool 103 via gateway 121. This data communication may be utilized to instantiate an emulation mode of scan tool 103, similarly to the functions of specialized machine 131 described above. Alternatively, remote scan tool 141 may instead utilize gateway 121 and scan tool 103 as intermediary data connections to indirectly interface with VCI 102, and perform the necessary service or diagnostic functions using remote processor 145 and/or remote memory 149. In such a configuration, scan tool 103 may be placed in a terminal mode, and provide its human-machine interface components to a user as an indirect way of interacting with remote scan tool 141.

Some machine-controlled type functions may be restricted via additional identifying information of the scan tool 103 or a user thereof. By way of example, and not limitation, additional identifying information may comprise a password, biometric identification, user login, or identification card reader. Other embodiments may comprise other machine-controlled type authorization schema without deviating from the teachings disclosed herein. Machine-controlled type functions may be accessible using only resources available to remote scan tool 141 and scan tool 103, or in some embodiments may also rely upon resources available to gateway 121 or specialized machine 131. In some embodiments, a plurality of remote scan tools 141 and/or specialized machines 131 may be utilized in coordination with gateway 121 and scan tool 103 to activate and operate machine-controlled type functions without deviating from the teachings disclosed herein.

Access to the authorizations provided by gateway 121, specialized machine 131, or remote scan tool 141 may be monitored by gateway 121, and gateway processor 125 may generate corresponding usage data indicating information pertaining to vehicle 100, scan tool 103, the user of scan tool 103, and associated service functions. This usage data may be utilized by providers of service functions to scan tool 103 with sufficient data to bill users of scan tool 103. In the depicted embodiment, the usage data may be generated by gateway processor 125 and transmitted to a billing server 151 in data communication with gateway 121. Billing server 151 has a billing processor 153, billing memory 155, and billing transceiver 159, though other embodiments may comprise distinct transmitters and receivers without deviating from the teachings disclosed herein. In response to receiving usage data, billing server 151 may generate billing data that may be transmitted to a user of scan tool 103. The billing data may be generated in an ad hoc fashion, or may indicate a hierarchy of subscription-based services that are accessible during a time of active subscription. Some embodiments may comprise a combination of ad hoc and subscription-based billing for different functions or users without deviating from the teachings disclosed herein. The billing data may be delivered to scan tool 103 via an indirect connection using gateway 121, or it may be delivered to a user via another channel, such as e-mail, fax transmission, postal delivery, or any other billing delivery method recognized by one of ordinary skill in the art without deviating from the teachings disclosed herein.

Users of scan tool 103 may transmit requests to gateway 121 to activate ad hoc or subscription payments in real-time in order to activate authorizations for needed service functions without having to interrupt usage of scan tool 103. In some embodiments, scan tool 103 may provide a user with options to “opt-in” to a payment needed to access a particular authorization, but other embodiments may automatically opt-in and establish payment without deviating from the teachings disclosed herein. In some embodiments, the opt-in options may direct a user to a hierarchy of subscriptions for specialized functions, or individual specialized functions may be activated on an ad hoc basis as they are needed without deviating from the teachings disclosed herein.

Access to some, but not all, functions of scan tool 103 may advantageously be acquired by an authorization management function of gateway 121. The operators of gateway 121 may offer different tiers of service for different pricing schema to users of scan tool 103. The operators of gateway 121 may, for example, offer one tier of subscription service for gateway-controlled type functions, but a different tier of service for access to the functions provided by specialized machine 131 and/or remote scan tool 141. Alternatively, the operators of gateway 121 may offer different tiers of subscription service for access to gateway-controlled type functions and/or machine-controlled type functions, but also allow users of scan tool 103 access to individual functions for an ad hoc fee. This arrangement may advantageously permit the operators of gateway 121 to purchase licenses from the operators of specialized machine 131 or remote tool 141 and provide the associated functions at a comparatively reduced cost to multiples users of a scan tool 103.

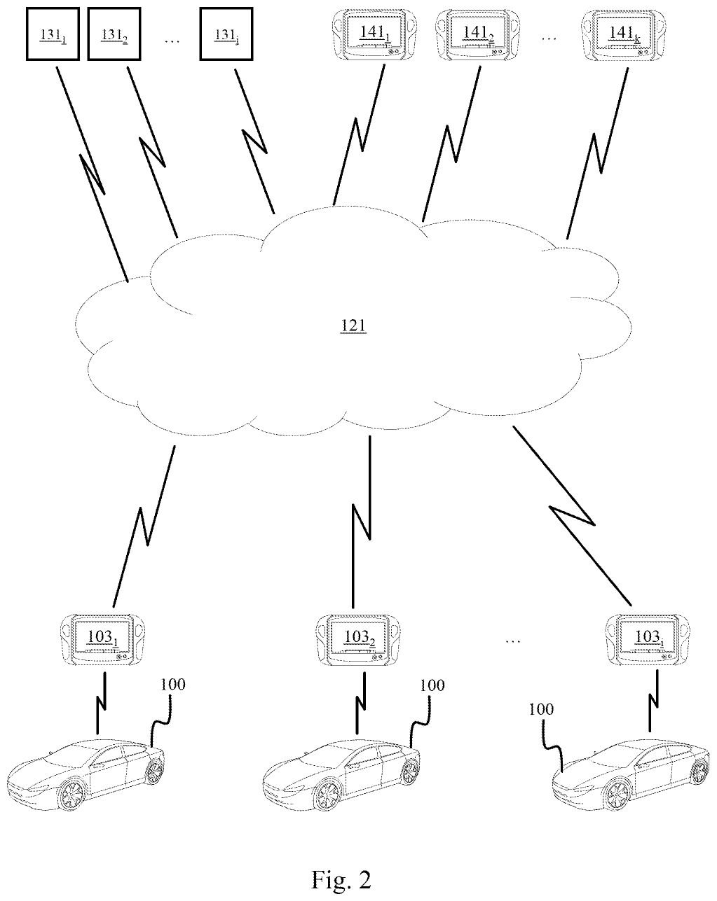

FIG. 2 is an illustration of such an authorization management arrangement in practice. An arbitrary of number i of scan tools 103, each performing service on an associated vehicle 100 are in data communication with gateway 121. It is noted that each of vehicles 100 may be of different make or model without deviating from the teachings disclosed herein. Gateway 121 is in turn in data communication with an arbitrary number j of specialized machines 131 and a different arbitrary number k of remote scan tools 141. In the depicted embodiment, gateway 121 may be configured to permit a finite number of simultaneous connections between scan tools 103 and any particular specialized machine 131 or remote scan tool 141. If the limit of simultaneous connections is reached for any particular specialized machine 131 or remote scan tool 141, gateway 121 may restrict data communication between that particular external device and any addition scan tools 103 until at least one of the established authorizations has been terminated. Authorizations may be managed based upon a usage schema, wherein a scan tool 103 is granted authorization and associated data communication for a service function until that service function is completed for an associated vehicle. Authorizations may additionally be managed based upon a time-based schema, wherein access to a particular service function by a particular scan tool 103 remains active for a predetermined window of time after authorization is requested by the scan tool 103 and established. In the depicted embodiment, a “round robin” management system is in place, wherein the granted authorization is terminated based upon the earlier of either completion of the service function, or a predetermined window of time has elapsed since the authorization was established. This round robin management advantageously optimizes the availability of service functions to users of scan tools 103 by making authorizations for each function available as rapidly as possible for use by another user of the system.

Requested and activated authorizations are monitored by gateway 121 and included in usage data transmitted to billing server 151 (not shown, see FIG. 1). This arrangement advantageously permits operators of specialized machines 131 or remote scan tools 141 to dynamically change aspects of their operation without interrupting the operability of the user of any of scan tools 103. Operators of specialized machines 131 can update the associated service functions, remove outdated functions, or add new functions without requiring updates to be provided locally to each user of scan tool 103. Similarly, operators of remote scan tools 141 can update the associated service functions, remove outdated functions, or add new functions without requiring updates to be provided locally to each user of scan tool 103. In the depicted embodiment, gateway 121 is configured to track the system requirements for each of the functions as they are updated and transmit data to a scan tool 103 if that particular scan tool 103 is not suitable to perform the new or updated service function. In the instance of an updated service function, gateway 121 may advantageously be configured to provide access to an alternate external device that can provide a previous version of the service function that is still compatible with the hardware, software, or firmware of a particular scan tool 103. In the depicted embodiment, gateway 121 is additionally configured to provide updates to software and firmware components of a scan tool 103 corresponding to updated or new service functions may available via gateway 121. In some such embodiments, gateway 121 may provide access to those updates in accordance with a subscription status or an ad hoc payment. In such embodiments, this payment may be accommodated for in the billing data transmitted to billing server 151 without deviating from the teachings disclosed herein.

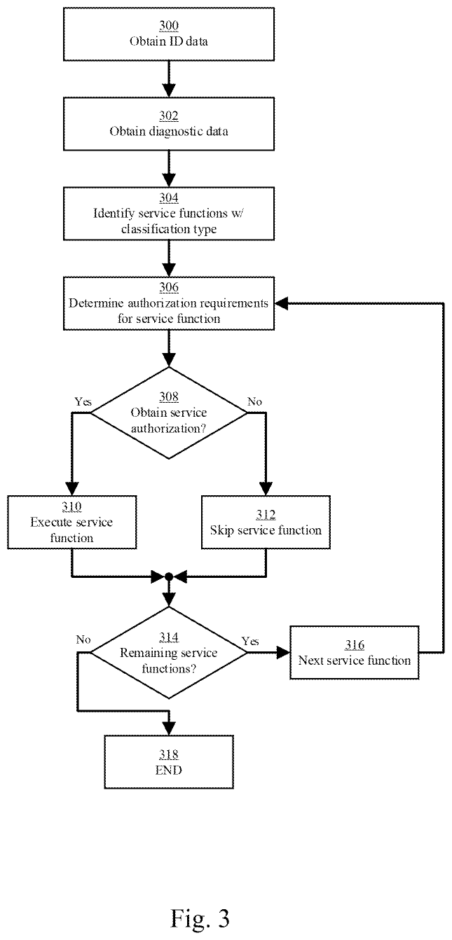

FIG. 3 is a flowchart illustrating a method of managing a diagnostic system, such as the system depicted in FIG. 1 and FIG. 2. The method starts at step 300, where the system obtains identification data. The identification data includes information indicating the make and model of the vehicle under service. The identification data may also include information about the user of a scan tool (such as scan tool 103; see FIG. 1), such as a user's identity, a user's certifications or licenses, a user's subscription status with a gateway (such as authorization gateway 121: see FIG. 1), a user's contractual obligations with an OEM, or a user's contractual obligations with an insurance company. Any other identifying information recognized by one of ordinary skill in the art may be obtained in this step without deviating from the teachings disclosed herein.

After identifying information is obtained, the method proceeds to step 302, where diagnostic data indicating the condition of a vehicle (such as vehicle 100; see FIG. 1) under service is obtained. The diagnostic data may comprise proprietary data, or may include diagnostic trouble code (DTC) data. Other forms of diagnostic data may be utilized without deviating from the teachings disclosed herein. After diagnostic data is obtained, the method proceeds to step 304 where a list of service functions is generated, each of the service functions being associated with a classification type.

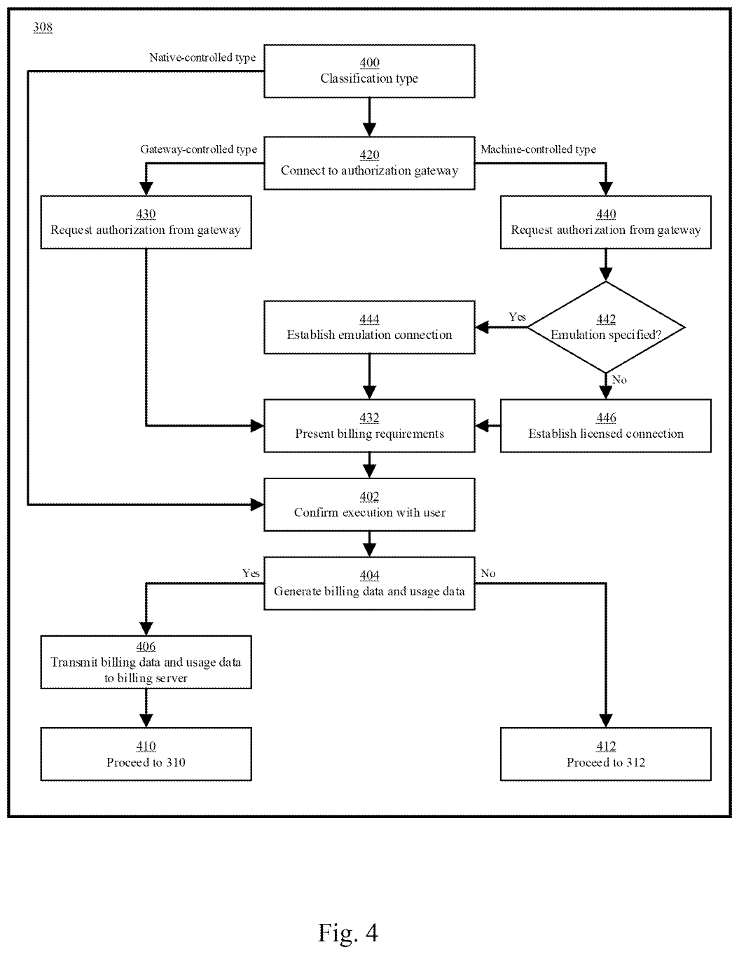

After the list of service functions is generated, the method proceeds to step 306, where the authorization requirements associated with a first service function are determined. This determination is based upon the classification type of the service function. In the depicted embodiment, there may be three classification types: a native-controlled type function, a gateway-controlled function, and a machine-controlled function. After the classification type and authorization requirements are determined for the service function, the method proceeds to step 308, where it is determined whether or not service authorization is required, and if so, can it be obtained. This determination may be as simple as presenting a user with a confirmation prompt on an interface of an associated scan tool, but other arrangements may be utilized. Additional teachings directed to step 308 will be discussed later with respect to FIG. 4.

At step 308, if an appropriate level of service authorization can be acquired, the method proceeds to step 310, where the service function is executed. This execution may be performed entirely by a scan tool without any external resources, for example if the service function has a native-controlled type classification. The execution may also be performed in coordination with resources external to the scan tool, such as an authorization gateway (such as gateway 121; see FIG. 1), a specialized machine (such as specialized machine 131; see FIG. 1), or a remote scan tool (such as remote scan tool 141; see FIG. 1). In the depicted embodiment, some service functions may require an emulation mode operation of an associated scan tool without deviating from the teachings disclosed herein. In the depicted embodiment, some service functions may be executed by external devices to the associated scan tool—effectively utilizing the scan tool as a remote terminal to the operation-without deviating from the teachings disclosed herein.

If the service authorization cannot be obtained, then the method instead proceeds to step 312, where the necessary service function is skipped and the associated diagnostic data is not addressed. By way of example, and not limitation, service authorization may be denied if the user of the scan tool lacks a certification or a subscription status to access the service function. In another example, service authorization may be denied in order to comply with a user's contractual obligation with an external party, such as an insurer or an OEM. In another example, service authorization may be denied if a customer of the user (e.g., the vehicle's owner) declines the offered service (e.g., if the customer does is unwilling or unable to pay for the service). Other examples may exist without deviating from the teachings disclosed herein.

After the service function has either been executed at step 310 or skipped at step 312, the method proceeds to step 314 to determine if any additional service functions are required to accommodate for unaddressed diagnostic data. If the diagnostic data indicates additional service functions are required or requested, then the method returns to step 306 to address the next service function in the generated list. This process continues iteratively until all the service functions of the generated list have been addressed, whether that means execution or skipping thereof. Once all the service functions of the list have been addressed by either step 310 or step 312, the method can instead proceed to step 318, where the method completes.

With additional regard to step 308, obtaining service authorization for a given service function requires a number of sub-steps that are illustrated by the flowchart depicted in FIG. 4. The sub-method of FIG. 4 begins at step 400, where the active service function's classification type is already known from step 306 (see FIG. 3). In the depicted embodiment, three classification types are possible: a native-controlled type, a gateway-controlled type, and a machine-controlled type. Additional classification types may be utilized in other embodiments without deviating from the teachings disclosed herein.

If the service function comprises a native-controlled type, then no additional resources external to the scan tool are required for the scan tool to execute the service function. This represents the simplest path through the flowchart. For the native-controlled type, the method proceeds to step 402, where execution of the service function is confirmed with the user of the scan tool. This confirmation comprises a check to ensure that the service function should be completed. In the depicted embodiment, it may comprise a prompt that is presented to the user of a scan tool to ensure that the customer has agreed to pay for the service associated with the execution of the service function. However, the confirmation may additionally utilize identification data of the user to be used for additional determinations. By way of example, and not limitation, the scan tool may request and acquire user credentials to ensure that the user is qualified. The user credentials may comprise a password input by the user. The user credentials may comprise presentation of a badge, keycard, fob, or other hardware credential that interacts with the scan tool. The user credentials may comprise a biometric scan of the user, such as a fingerprint scan, facial recognition, or voice recognition. The user credentials may also be passive from the user's perspective, and instead be a cross-reference of the user's licenses, certifications, and permissions with a stored list of necessary licenses, certifications, and permissions required for a particular service operation. For some service functions, the confirmation step 402 may only comprise a prompt and response interaction with the user, without requiring additional credentials, without deviating from the teachings disclosed herein.

After the user has confirmed whether or not the service function will be completed, the method proceeds to step 404, where billing data and usage data is generated for the intended result of the confirmation. If the user confirms that a service function will not be executed, the billing data and usage data is updated to indicate that no service was performed utilizing that particular service function. Otherwise, the billing data and usage data is updated to reflect the execution of the service function, which can be used by the scan tool or an external device (such as a billing server 151; see FIG. 1) to generate an invoice for the customer. The billing data and usage data may advantageously utilize protocols that generate separate entities for multiple customers, e.g., if the user is utilizing automotive insurance but is still required to pay a deductible. In the depicted embodiment, when billing data and usage data is generated to indicate a service and associated charge, the method proceeds to step 406, where the billing data and usage data is transmitted to an external billing server. In some embodiments, this data may be retained, and invoices and other accounting information may be generated directly by the scan tool without deviating from the teachings disclosed herein. After transmission of the billing and usage data, the method proceeds to step 410, and the method exits this sub-method and proceeds to step 310 of FIG. 3. If at step 404 it is determined that no billing data or usage data is to be generated, the method instead proceeds to step 412, wherein the method exits this sub-method and proceeds to step 312 of FIG. 3.

The flowchart is lengthier for other classification types of service function. If the service function is found to not be a native-controlled type at step 400, the method instead proceeds to step 420, where the scan tool connects in data communication with an authorization gateway (such as gateway 121; see FIG. 1). For the other classification types of service function, the scan tool will rely on at least additional resources from the gateway to execute the associated service function.

If the service function is of the gateway-controlled type, the method proceeds to step 430, where authorization is requested from the gateway to execute the service function. If a finite number of simultaneous accesses to the service function are permitted, the gateway checks to ensure that this limit has not been exceeded. If the limit has been exceeded, the gateway may wait to respond until another user is no longer utilizing the service function and the number of simultaneous users is below the limit. In the depicted embodiment, the gateway may additionally generate a prompt to permit a user to purchase additional access, either as an enhanced subscription or on an ad hoc basis. Other embodiments may comprise other arrangements without deviating from the teachings disclosed herein.

If the limit is not exceeded, the gateway then compares a user's status with a subscription requirement for the service function. The gateway will generate a set of billing requirements for the user to access the desired service function. If the user is appropriately subscribed to access the service function, the billing requirements may be replaced with an indication that access is permitted. If the user is not appropriately subscribed then at step 432 the billing requirements are presented. In the depicted embodiment, the billing requirements may comprise an option between activating a new subscription, reactivating an expired subscription, or making an ad hoc purchase to activate the service function. Some embodiments may comprise a different set of options without deviating from the teachings disclosed herein.

After the user is presented with the associated billing requirements, the method proceeds to step 402, where this information is utilized in addition to the other confirmation elements already disclosed, and the method proceeds through the remaining steps as disclosed above.

If at step 420 the service function is a machine-controlled type, this authorization requires at least authorization from an external device other than the gateway. Similar to as described above with respect to gateway-controlled type service functions, the method proceeds to step 440, wherein authorization is requested by the gateway to an external device, such as a specialized machine or a remote scan tool. If a finite number of simultaneous accesses to the external device are permitted, the gateway checks to ensure that this limit has not been exceeded. If the limit has been exceeded, the gateway may wait to respond until another user is no longer utilizing the service function and the number of simultaneous users is below the limit. In the depicted embodiment, the gateway may additionally generate a prompt to permit a user to purchase additional access, either as an enhanced subscription or on an ad hoc basis. Other embodiments may comprise other arrangements without deviating from the teachings disclosed herein.

Once the gateway ascertains that access to the service function may be authorized at step 440, the method proceeds to step 442, wherein the classification type of the service function is further examined for additional operation. In the depicted embodiment, a machine-controlled type classification indicates whether the service function must be accessed and executed via an emulation mode of the scan tool, or via a licensed connection. In the emulation mode, an external device (typically a specialized machine, such as specialized machine 131; see FIG. 1) utilizes resources of the scan tool via an intermediary data connection of the gateway to engage the scan tool in an emulation mode capable of executing the service function. If an emulation mode is specified, the method proceeds to step 444 where this emulation connection is established. If a licensed connection is established, the scan tool is instead accessed by the external device (typically a remote scan tool, such as remote scan tool 141) and the external device utilizes its own resources to perform the service function, utilizing the user's scan tool as an interface for the external device.

After the appropriate connection is determined and established, the method proceeds from either step 444 or step 446 to step 432, where appropriate billing requirements are determined and presented to the user based on the emulation connection or licensed connection. If the user is appropriately subscribed to access the service function, the billing requirements may be replaced with an indication that access is permitted. If the user is not appropriately subscribed, then at step 432 the billing requirements are presented. In the depicted embodiment, the billing requirements may comprise an option between activating a new subscription, reactivating an expired subscription, or making an ad hoc purchase to activate the service function. Some embodiments may comprise a different set of options without deviating from the teachings disclosed herein.

From step 432, the method continues for machine-controlled type service functions as described above with respect to native-controlled type and gateway-controlled type service functions.

Other embodiments may comprise deviations from the embodiment depicted herein without deviating from the teachings disclosed. By way of example, and not limitation, some embodiments may not comprise one or more of steps 406, 442, 444, or 446 without deviating from the teachings disclosed above. In embodiments utilizing additional classification types than those described herein, the method may utilize additional branches of the flowchart depicted without deviating from the teachings disclosed herein. In some embodiments, steps 432 and 402 may be combined into a single step, or both may be omitted without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of operating a scan tool for a vehicle, the method comprising:
obtaining identification data from the vehicle, the identification data identifying the make and model of the vehicle;
obtaining a code from the vehicle indicating diagnostic service needs of the vehicle;
identifying a service function suitable for the vehicle in response to the identification data and the code, the service function having a classification type;
determining if an authorization is necessary for completion of the service function based on the classification type;
requesting an authorization from an authorization gateway in response to the classification type necessitating an authorization before executing the service function;
receiving the authorization from the authorization gateway in response to the request; and
executing the service function.

2. The method of claim 1, further comprising:
generating usage data indicating information pertaining to the vehicle, user of the scan tool, and service function; and
transmitting usage data to a billing server comprising a billing processor and a billing memory.

3. The method of claim 2, further comprising generating billing data in response to the usage data.

4. The method of claim 1, wherein the authorization expires after the earlier of either the completion of the service function or a predetermined time period has lapsed.

5. The method of claim 1, wherein the classification type is a native type, a gateway-controlled type, or a machine-controlled type, wherein the native type does not require an authorization from the authorization gateway, and wherein the gateway-controlled type and machine-controlled type each require an authorization from the authorization gateway.

6. The method of claim 5, wherein the authorization is acquired by the authorization gateway from a specialized diagnostic machine in response to the classification type being the machine-controlled type.

7. The method of claim 6, further comprising executing the service function via an emulation of the specialized diagnostic machine in response to receiving the authorization form the authorization gateway when the classification type is the machine-controlled type.

8. A diagnostics system for performing service functions on a vehicle under service, the system comprising:
a scan tool having a tool processor and a tool memory;
an authorization gateway in data communication with the scan tool, the authorization gateway having a gateway processor and a gateway memory; and
a specialized machine in data communication with the authorization gateway, the specialized machine comprising a specialized processor and a specialized memory;
wherein the tool memory comprises executable instructions for a number of service functions, some of the service functions having a classified type requiring an authorization to be operable by the scan tool, wherein the authorization memory comprises a number of first authorization assets to enable the scan tool to perform a service function having a first classified type, wherein the specialized memory comprises a number of second authorization assets to enable the scan tool to perform a service function having a second classified type, wherein the scan tool is configured to request a first authorization asset prior to performing a service function of the first classified type, wherein the scan tool is configured to request a second authorization asset prior to performing a service function of the second classified type, and wherein the scan tool is configured to establish a diagnostics communication with the vehicle under service.

9. The diagnostics system of claim 8, wherein the first authorization assets and the second authorization assets are stored temporarily by the tool memory in response to a request from the scan tool, each of the first authorization assets and the second authorization assets expiring in the tool memory after a predetermined lapse of time.

10. The diagnostics system of claim 8, wherein the scan tool is configured to request an authorization asset from the gateway-processor in response to a request to perform a service function having the first classified type or the second classified type.

11. The diagnostics system of claim 8, wherein the specialized machine is further configured to establish an emulation connection to the scan tool via the authorization gateway, the emulation connection permitting emulation of a service function by the scan tool while a second authorization asset is transmitted to the scan tool.

12. The diagnostic system of claim 8, further comprising a billing server comprising a billing processor and a billing memory, wherein the scan tool is configured to generate usage data in response to operation of diagnostic functions and transmit the usage data to the billing server.

13. The diagnostic system of claim 12, wherein the billing server is configured to generate billing data in response to receiving the usage data.

14. The diagnostic system of claim 12, wherein the usage data comprises vehicle identification data, user identification data, and a list of functions utilized by the scan tool having either the first classified type or the second classified type.

15. A scan tool for servicing a vehicle, the scan tool comprising a tool processor and a tool memory, the tool memory comprising instructions stored thereon that, when executed by the tool processor, cause the tool processor to:
obtain identification data from the vehicle, the identification data identifying the make and model of the vehicle;
obtain a code from the vehicle indicating diagnostic service needs of the vehicle;
identify a service function suitable for the vehicle in response to the identification data and the code, the service function having a classification type;
determine if an authorization is necessary for completion of the service function based on the classification type;
request an authorization from an authorization gateway in response to the classification type necessitating an authorization before executing the service function;
receive the authorization from the authorization gateway in response to the request; and
execute the service function.

16. The scan tool of claim 15, wherein the tool memory further comprises instructions that, when executed by the tool processor, cause the tool processor to:
generate usage data indicating information pertaining to the vehicle, user of the scan tool, and service function; and
transmit usage data to a billing server comprising a billing processor and a billing memory.

17. The scan tool of claim 15, wherein the tool memory further comprises instructions that, when executed by the tool processor, cause the tool processor to:
terminate the authorization after the earlier of either the completion of the service function or a predetermined time period has lapsed.

18. The scan tool of claim 15, wherein the classification type is a native type, a gateway-controlled type, or a machine-controlled type, wherein the native type does not require an authorization from the authorization gateway, and wherein the gateway-controlled type and machine-controlled type each require an authorization from the authorization gateway.

19. The scan tool of claim 18, wherein the tool memory further comprises instructions that, when executed by the tool processor, cause the tool processor to:
execute the service function via an emulation of a specialized diagnostic machine in response to receiving the authorization form the authorization gateway when the classification type is the machine-controlled type.
